(19) United States
(12) Patent Application Publication
(10) Pub. No.: US 2026/0112643 A1
(43) Pub. Date: Apr. 23, 2026

(54) SOLID ELECTROLYTE-CONDUCTIVE MATERIAL COMPOSITE AND POSITIVE ELECTRODE MATERIAL INCLUDING THE COMPOSITE

(71) Applicants: HYUNDAI MOTOR COMPANY, Seoul (KR); Kia Corporation, Seoul (KR); KOREA ELECTRONICS TECHNOLOGY INSTITUTE, Seongnam-si (KR)

(72) Inventors: Jae Seong HWANG, Hwaseong-si (KR); Young Jun HONG, Hwaseong-si (KR); Kyung Yup SONG, Hwaseong-si (KR); Ye Seul PARK, Hwaseong-si (KR); Sang Hun JEONG, Hwaseong-si (KR); Do Yun KWON, Hwaseong-si (KR); Byoung Cheon JEONG, Hwaseong-si (KR); So Yeon PARK, Hwaseong-si (KR); Ji Sang YU, Seongnam-si (KR); Kyung Su KIM, Yongin-si (KR); Yun Chae JUNG, Seoul (KR); Keon Ho PARK, Seongnam-si (KR); Woo Suk CHO, Seongnam-si (KR)

(73) Assignees: HYUNDAI MOTOR COMPANY, Seoul (KR); Kia Corporation, Seoul (KR); KOREA ELECTRONICS TECHNOLOGY INSTITUTE, Seongnam-si (KR)

(21) Appl. No.: 19/246,336

(22) Filed: Jun. 23, 2025

(30) Foreign Application Priority Data
Oct. 21, 2024 (KR) 10-2024-0144378

(51) Int. Cl. H01M 4/62; H01M 4/131; H01M 4/36; H01M 10/052

(52) U.S. Cl. CPC H01M 4/628; H01M 4/131; H01M 4/366; H01M 4/625; H01M 10/052

(57) ABSTRACT

Disclosed is a composite obtained by combining a chloride-based solid electrolyte having excellent stability under high-voltage conditions with a carbon-based conductive material into a composite. Further, a positive electrode material including the composite, a positive electrode including the same, and an all-solid-state battery including the same are disclosed. The composite has excellent balance between ionic conductivity and electronic conductivity and has excellent stability in a voltage range in which the battery operates, and thus is applied as a coating layer on a surface of the positive electrode active material to improve performance.

### CROSS-REFERENCE TO RELATED APPLICATION

This application claims the benefit of priority to Korean Patent Application No. 10-2024-0144378, filed in the Korean Intellectual Property Office on Oct. 21, 2024, the entire contents of which are incorporated herein by reference.

### TECHNICAL FIELD

The present disclosure relates to a solid electrolyte-conductive material composite obtained by combining a solid electrolyte having stability under a high voltage condition and a conductive material each other into a composite, such that the composite may exhibit excellent ion conductivity and electron conductivity in a battery operating range. Further, the present disclosure relates to a positive electrode material including the composite, a positive electrode including the same, and an all-solid-state battery including the same.

### BACKGROUND

Various batteries that may overcome the limitations of current lithium ion batteries in terms of battery capacity, stability, output, large-scale, and ultra-miniaturization are being studied. Among the various batteries, an all-solid-state battery refers to a battery in which the electrolyte used in a conventional lithium secondary battery is replaced with a solid. The all-solid-state battery does not use a flammable solvent, such that there is no concern about ignition or explosion due to the decomposition reaction of the conventional electrolyte. Thus, stability of the battery may be significantly improved. Furthermore, because all materials used in the all-solid-state battery are solid, it is easy to diversify the materials and the shape of the battery. The all-solid-state battery is advantageous in implementing high-voltage cells and high energy density using a direct stacking scheme and thus is the next-generation batteries that are receiving the most attention.

Further, the solid electrolyte is one of the most important components of the all-solid-state battery. The solid electrolyte is contained in both the active material layer and the solid electrolyte layer to secure the ion migration path. Currently, the most widely used solid electrolyte is the sulfide-based solid electrolyte, which has high lithium ion conductivity and stability over a wide voltage range. In particular, there are previous studies that attempt to combine the sulfide-based solid electrolyte and the conductive material with each other into a composite to secure both electronic and ionic conductivities.

However, the sulfide-based solid electrolyte has the disadvantage of being easily oxidized in an operating range of the battery, thereby damaging an ion transfer path. Thus, research on a solid electrolyte composite that may be stable even in the actual operating range of the battery is necessary.

### SUMMARY

The present disclosure has been made to solve the above-mentioned problems occurring in the prior art while advantages achieved by the prior art are maintained intact.

An aspect of the present disclosure provides a solid electrolyte-conductive material composite capable of solving the above-mentioned problem, a positive electrode material including the composite, a positive electrode including the same, and an all-solid-state battery including the same.

More specifically, a purpose of the present disclosure is to provide a solid electrolyte-conductive material composite obtained by combining a chloride-based solid electrolyte having stable characteristics even under the operating pressure conditions of the battery and a conductive material with each other into a composite, such that the composite is capable of simultaneously secure ion conductivity and electronic conductivity along with stability at high voltage, and the composite is coated on a positive electrode active material surface to reduce interfacial resistance. Further, a purpose of the present disclosure is to provide a positive electrode material including the composite, a positive electrode including the same, and an all-solid-state battery including the same.

The technical problems to be solved by the present disclosure are not limited to the aforementioned problems, and any other technical problems not mentioned herein will be clearly understood from the following description by those skilled in the art to which the present disclosure pertains.

In order to achieve the above-mentioned purpose, the present disclosure provides a composite, a positive electrode material including the composite, a positive electrode including the same, and an all-solid-state battery including the same.

More specifically, (1) the present disclosure provides a composite including: a solid electrolyte represented by a following Chemical Formula 1; and a carbon-based conductive material:

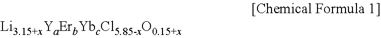

where in the Chemical Formula 1,

$$0 \leq a \leq 1 , 0 \leq b \leq 1 , 0 \leq c \leq 1 , a + b + c = 1 , - 0.1 \leq x \leq 0.1 .$$

(2) The present disclosure provides the composite of the (1), wherein the composite is at least one selected from the group consisting of Li_{3.15}YCl_{5.85}O_{0.15}, Li_{3.15}ErCl_{5.85}O_{0.15}, Li_{3.15}YbCl_{5.85}O_{0.15} and Li_{3.15}Y_{1/3}Er_{1/3}Yb_{1/3}Cl_{5.85}O_{0.15}.

(3) The present disclosure provides the composite of the (1) or (2), wherein the carbon-based conductive material is at least one selected from the group consisting of carbon black, single-walled carbon nanotubes, multi-walled carbon nanotubes, and graphene.

(4) The present disclosure provides the composite of one of the (1) to (3), wherein a content of the carbon-based conductive material in the composite is in a range of 0.1 wt % inclusive to 10 wt % inclusive.

(5) The present disclosure provides the composite of one of the (1) to (4), wherein an oxidation current flows in the composite at a voltage of 4.25 V (vs. Li/Li⁺) or greater.

(6) The present disclosure provides a positive electrode material including: a positive electrode active material; and a coating layer formed on at least a portion of a surface of the positive electrode active material, wherein the coating layer includes the composite according to one of the (1) to (5).

(7) The present disclosure provides the positive electrode material of the (6), wherein the positive electrode active material is an oxide active material or a sulfide active material.

(8) The present disclosure provides the positive electrode material of the (6) or (7), wherein the positive electrode active material is a lithium metal oxide-based positive electrode active material having a layered structure.

(9) The present disclosure provides the positive electrode material of one of the (6) to (8), wherein a thickness of the coating layer is in a range of 50 nm inclusive to 200 nm inclusive.

(10) The present disclosure provides the positive electrode material of one of the (6) to (9), wherein a weight ratio between the positive electrode active material and the composite is in a range of 70:30 to 99:1.

(11) The present disclosure provides a positive electrode including: a positive electrode active material layer; and a current collector, wherein the positive electrode active material layer includes the positive electrode material according to one of the (6) to (10).

(12) The present disclosure provides the positive electrode of the (11), wherein the positive electrode active material layer includes a solid electrolyte and a conductive material.

(13) The present disclosure provides the positive electrode of the (12) or (13), wherein the solid electrolyte contained in the positive electrode active material layer is a sulfide-based solid electrolyte.

(14) The present disclosure provides an all-solid-state battery including: the positive electrode according to one of the (11) to (13); a negative electrode; and a solid electrolyte layer interposed between the positive electrode and the negative electrode.

### BRIEF DESCRIPTION OF THE DRAWINGS

The above and other objects, features and advantages of the present disclosure will be more apparent from the following detailed description taken in conjunction with the accompanying drawings:

FIG. 1 shows an I-V graph and a second order derivative graph thereof as obtained on a composite according to Example 4 of the present disclosure;

FIG. 2 shows an I-V graph and a second order derivative graph thereof as obtained on a composite according to Comparative Example 8 of the present disclosure.

FIG. 3 shows a charge/discharge graph of an all-solid-state battery using a composite of each of Examples 3 to 5 and Comparative Examples 6 to 8 of the present disclosure;

FIG. 4 shows a charge/discharge graph based on a change in a current density of an all-solid-state battery according to Example A of the present disclosure;

FIG. 5 shows a charge/discharge graph based on a change in a current density of an all-solid-state battery according to Comparative Example A of the present disclosure;

FIG. 6 shows a charge/discharge graph based on a change in a current density of an all-solid-state battery according to Comparative Example B of the present disclosure;

FIG. 7 shows a charge/discharge graph based on a change in a current density of an all-solid-state battery according to Comparative Example C of the present disclosure;

FIG. 8 shows a charge/discharge graph based on a change in a current density of an all-solid-state battery according to Comparative Example D of the present disclosure;

FIG. 9 shows a charge/discharge graph based on a change in a current density of an all-solid-state battery according to Comparative Example E of the present disclosure;

FIG. 10 shows a graph showing a change in a discharge capacity based on the number of cycles of an all-solid-state battery according to each of Example A and Comparative Examples A to E of the present disclosure; and

FIG. 11 is a diagram showing an observation of a positive electrode active material of each of Example A and Comparative Example A of the present disclosure.

### DETAILED DESCRIPTION

Hereinafter, the present disclosure will be described in more detail.

Terms or words used in this specification and claims should not be interpreted as limited to their usual or dictionary meanings, and should be interpreted as meanings and concepts that comply with the technical ideas of the present disclosure based on the principle that the inventor may appropriately define the concept of the term in order to explain his or her own invention in the best way.

The composite, the positive electrode material, the positive electrode, and the all-solid-state battery of the present disclosure are described in detail below.

### Solid Electrolyte-Conductive Material Composite

The present disclosure provides a composite including a solid electrolyte represented by a following Chemical Formula land a carbon-based conductive material:

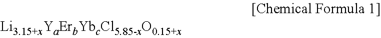

where in the Chemical Formula 1,

$$0 \leq a \leq 1 , 0 \leq b \leq 1 , 0 \leq c \leq 1 , a + b + c = 1 , - 0.1 \leq x \leq 0.1 .$$

Previous studies have already been conducted to combine the sulfide-based solid electrolyte having various advantages and carbon with each other into a composite to improve the electronic conductivity. However, the sulfide-based solid electrolyte has the disadvantage of being easily oxidized in the operating voltage range of the battery, resulting in low stability. Accordingly, the present disclosure provides a solid electrolyte-conductive material composite obtained by combining a specific chloride-based solid electrolyte not easily oxidized in the operating voltage range of the battery with a carbon-based conductive material into a composite which secures both ionic and electronic conductivities while also ensuring stability.

More specifically, the solid electrolyte contained in the composite of the present disclosure is a chloride-based solid electrolyte, which may be represented by the following Chemical Formula 1.

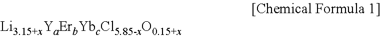

In the Chemical Formula 1,

$$0 \leq a \leq 1 , 0 \leq b \leq 1 , 0 \leq c \leq 1 , a + b + c = 1 , - 0.1 \leq x \leq 0.1 .$$

The chloride-based solid electrolyte represented by the Chemical Formula 1 is a general chloride-based solid electrolyte in which some of the chloride ions are replaced with oxygen ions. Unlike the existing solid electrolyte, the chloride-based solid electrolyte represented by the Chemical Formula 1 is structurally stable even under high-temperature conditions, thereby maintaining ion conductivity while providing excellent thermal and chemical stability. In particular, the chloride-based solid electrolyte represented by the Chemical Formula 1 does not crystallize even at high temperatures, and thus, decrease in the ion conductivity that may occur due to crystallization does not occur, and a side reaction thereof with the positive electrode active material may also be suppressed.

More specifically, the solid electrolyte may be at least one selected from the group consisting of Li_{3.15}YCl_{5.85}O_{0.15}, Li_{3.15}ErCl_{5.85}O_{0.15}, Li_{3.15}YbCl_{5.85}O_{0.15} and Li_{3.15}Y_{1/3}Er_{1/3}Yb_{1/3}Cl_{5.85}O_{0.15}, and preferably, Li_{3.15}YCl_{5.85}O_{0.15}. The solid electrolyte may exhibit excellent ion conductivity and, at the same time, excellent thermal and chemical stability even in a high-temperature environment.

The chloride-based solid electrolyte may be prepared by mixing LiCl, Li₂O, and metal (M) chloride with each other. The mixing may be performed through mechanical milling treatment such as ball milling. The preparation of the chloride-based solid electrolyte may be performed in a glove box or a dry room, or may be performed under an inert gas atmosphere, so as to minimize exposure to oxygen or moisture in the atmosphere.

In one example, the composite of the present disclosure may be a composite into which the chloride-based solid electrolyte and the carbon-based conductive material are combined with each other, or may be a uniform mixture of the chloride-based solid electrolyte and the carbon-based conductive material.

The carbon-based conductive material may be at least one selected from the group consisting of carbon black, single-walled carbon nanotubes, multi-walled carbon nanotubes, and graphene, and may preferably be carbon black. The carbon-based conductive material may be easily combined with the chloride-based solid electrolyte into the composite, and may supplement the insufficient electronic conductivity of the chloride-based solid electrolyte.

A content of the carbon-based conductive material in the composite may be in a range of about 0.1 wt % inclusive to about 10 wt % inclusive. Preferably, the content of the carbon-based conductive material may be about 0.1 wt % or greater, about 0.2 wt % or greater, about 0.3 wt % or greater, about 0.4 wt % or greater, about 0.5 wt % or greater, about 1.0 wt % or greater, about 1.5 wt % or greater, or about 2.0 wt % or greater, and may be about 10 wt % smaller, about 9 wt % or smaller, about 8 wt % or smaller, about 7 wt % or smaller, about 6 wt % or smaller, or about 5 wt % or smaller. When the content of the conductive material is within the above-described range, the electronic conductivity and ionic conductivity of the composite may be improved in a balanced manner.

The composite of the present disclosure may be prepared by mixing the solid electrolyte represented by the Chemical Formula 1 as described above and the carbon-based conductive material with each other. A content of the carbon-based conductive material based on the mixture of the solid electrolyte and the carbon-based conductive material may be in a range of about 0.1 wt % inclusive to about 10 wt % inclusive. Preferably, the content thereof may be about 0.1 wt % or greater, about 0.2 wt % or greater, about 0.3 wt % or greater, about 0.4 wt % or greater, about 0.5 wt % or greater, about 1.0 wt % or greater, about 1.5 wt % or greater, or about 2.0 wt % or greater, and about 10 wt % smaller, about 9 wt % or smaller, about 8 wt % or smaller, about 7 wt % or smaller, about 6 wt % or smaller, or about 5 wt % or smaller.

The mixing process may be performed using milling. The milling may be performed using various known methods. For example, ball milling may be used. The carbon-based conductive material may be combined with the solid electrolyte into the composite via the milling.

The composite of the present disclosure may be characterized by having an oxidation current flowing at a voltage of 4.25 V (vs. Li/Li⁺) or greater. In combining a conventional sulfide-based solid electrolyte with a conductive material into a composite, the oxidation current flows in the composite in a low voltage range due to the deteriorated oxidation stability of the sulfide-based solid electrolyte. However, the composite of the present disclosure is obtained by combining the chloride-based solid electrolyte with excellent stability in a high voltage range with the carbon-based conductive material into a composite and thus is characterized in that the oxidation current flows therein in a high voltage range of about 4.25 V or higher. The voltage value at which the oxidation current flows is an indicator that may indicate the electrochemical oxidation stability of the composite. It may be determined that the higher the voltage range at which the oxidation current flows, the better the electrochemical oxidation stability is.

### Positive Electrode Material

The present disclosure provides a positive electrode material including the composite. More specifically, the present disclosure provides a positive electrode material including a positive electrode active material and a coating layer formed on at least a portion of a surface of the positive electrode active material, wherein the coating layer is characterized by including the composite as described above.

The positive electrode active material may be an oxide active material or a sulfide active material.

The oxide active material may be a rock salt layer-type active material as such LiCoO₂, LiMnO₂, LiNiO₂, LiVO₂, Li₁₊ₓNi_{1/3}CO_{1/3}Mn_{1/3}O₂, etc., a spinel-type active material such as LiMn₂O₄, Li(Ni_{0.5}Mn_{1.5})O₄, etc., a reverse spinel-type active material such as LiNiVO₄, LiCoVO₄, etc., an olivine-type active material such as LiFePO₄, LiMnPO₄, LiCoPO₄, LiNiPO₄, etc., a silicon-containing active material such as Li₂FeSiO₄, Li₂MnSiO₄, etc., a rock salt layer-type active material in which a portion of the transition metal is replaced with a heterogeneous metal, such as LiNi_{0.8}Co(_{0.2-x})AlₓO₂ (0<x<0.2), a spinel-type active material in which a portion of the transition metal is replaced with a heterogeneous metal, such as Li₁₊ₓMn_{2-x-y}M_{y}O₄ (M is at least one of Al, Mg, Co, Fe, Ni, and Zn, and 0<x+y<2), or lithium titanate such as Li₄Ti₅O₁₂. The sulfide active material may be copper Chevrel, iron sulfide, cobalt sulfide, nickel sulfide, etc.

In the positive electrode material of the present disclosure, a thickness of the coating layer may be in a range of about 50 nm inclusive to about 200 nm inclusive, and may be preferably about 50 nm or greater, about 60 nm or greater, about 70 nm or greater, about 80 nm or greater, or about 90 nm or greater, and about 200 nm smaller, about 180 nm or smaller, about 170 nm or smaller, about 160 nm or smaller, or about 150 nm or smaller. When the thickness of the coating layer is within the above-described range, a contact area for the transfer of ions and electrons may be maximized while preventing damage to the solid electrolyte on the surface of the positive electrode material.

In the positive electrode material of the present disclosure, a weight ratio between the positive electrode active material and the composite may be in a range of 70:30 to 99:1, and preferably 70:30 to 95:5, 75:25 to 95:5, 75:25 to 90:10, 75:25 to 85:15, or 80:20 to 85:15. When the content of the positive electrode active material is too high, the effect of the composite coating may be minimal. When the content of the positive electrode active material is too low, the content of the active material itself may decrease, resulting in decrease in efficiency.

### Positive Electrode

The present disclosure provides a positive electrode including the positive electrode active material described above. More specifically, the present disclosure provides a positive electrode including a positive electrode active material layer and a current collector, wherein the positive electrode active material layer includes the positive electrode material.

A material of the current collector may be used without particular limitation thereto as long as it is known to be commonly used as a material for a current collector of a positive electrode. For example, the current collector may be made of stainless steel, copper, aluminum, nickel, or titanium.

The positive electrode active material layer may include a solid electrolyte and a conductive material together with the positive electrode material as described above. A typical solid electrolyte and conductive material may be used as the solid electrolyte and conductive material, respectively.

More specifically, the solid electrolyte may be the same as the chloride-based solid electrolyte contained in the composite coated on the surface of the positive electrode material, or be different therefrom. For example, the sulfide-based solid electrolyte, the chloride-based solid electrolyte, or the oxide-based solid electrolyte may be used as the solid electrolyte. For excellent lithium ion conduction, the sulfide-based solid electrolyte may be used as the solid electrolyte. The sulfide-based solid electrolyte is not particularly limited. However, an example thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (where each of m and n is a positive number, and Z is one of Ge, Zn, or Ga), Li₂S—GeS₂, Li₂S—SiS₂—Li₃PO₄, Li₂S—SiS₂-LiₓMO_{y} (where each of x and y is a positive number, and M is one of P, Si, Ge, B, Al, Ga, or In), Li₁₀GeP₂S₁₂.

The conductive material may also be the same as or different from the carbon-based conductive material contained in the composite. In one example, the conductive material may be intended to secure electrical conductivity of the electrode active material layer and may include carbon black, conducting graphite, ethylene black, graphene, etc.

The positive electrode active material layer may include a binder for binding between the positive electrode active material, the conductive material, and the solid electrolyte. The binder is a component that may bind the components contained in the electrode active material layer to each other. A type of the binder may include BR (Butadiene rubber), NBR (Nitrile butadiene rubber), HNBR (Hydrogenated nitrile butadiene rubber), PVDF (polyvinylidene difluoride), PTFE (polytetrafluoroethylene), CMC (carboxymethylcellulose), etc.

A content of the active material in the positive electrode active material layer may be in a range of about 75 wt % to about 85 wt %, preferably about 80 wt % to about 83 wt %. Furthermore, the content of the binder may be in a range of about 1 wt % to about 3 wt %, preferably about 1.5 wt % to about 2 wt %. Furthermore, the content of the conductive material may be in a range of about 1 wt % to about 3 wt %, preferably about 1.5 wt % to about 2 wt %. In addition, the content of the solid electrolyte may be in a range of about 15 wt % to about 25 wt %, and preferably about 17 wt % to about 20 wt %.

### All-Solid-State Battery

The present disclosure provides an all-solid-state battery including the positive electrode described above. More specifically, the present disclosure provides an all-solid-state battery including the positive electrode, the negative electrode, and the solid electrolyte layer interposed between the positive electrode and the negative electrode.

The negative electrode that may be commonly used in the field of all-solid-state batteries may be used. The solid electrolyte layer may include the same solid electrolyte as described above with reference to the positive electrode, and may further include a conductive material and a binder.

Hereinafter, the present disclosure will be described in more detail based on Examples. However, the following Examples are intended to exemplify the present disclosure and the scope of the present disclosure is not limited to these Examples.

### Materials

Li_{3.15}Y_{1/3}Er_{1/3}Yb_{1/3}Cl_{5.85}O_{0.15} was used as the chloride-based solid electrolyte, and Li₆PS₅Cl was used as the sulfide-based solid electrolyte, and carbon black (SUPER C) was used as the carbon-based conductive material.

### EXAMPLE AND COMPARATIVE EXAMPLE

A composite was prepared by uniformly mixing the solid electrolyte and the carbon-based conductive material as set forth above at a certain content ratio. The type of the solid electrolyte used in each of Example and Comparative Example and the content ratio between the solid electrolyte and the conductive material used in each of Example and Comparative Example are summarized in Table 1 as set forth below.

TABLE 1

| | | Solid | Conductive |
|---|---|---|---|
| | | electrolyte | material |
| | | mass | mass |
| | Solid electrolyte | content(%) | content(%) |
| Comparative | Li₆PS₅Cl | 97 | 3 |
| Example 1 | | | |
| Comparative | Li₆PS₅Cl | 96 | 4 |
| Example 2 | | | |
| Comparative | Li₆PS₅Cl | 95 | 5 |
| Example 3 | | | |
| Comparative | Li₆PS₅Cl | 94 | 6 |
| Example 4 | | | |
| Comparative | Li₆PS₅Cl | 93 | 7 |
| Example 5 | | | |
| Comparative | Li₆PS₅Cl | 92 | 8 |
| Example 6 | | | |
| Comparative | Li₆PS₅Cl | 91 | 9 |
| Example 7 | | | |
| Comparative | Li₆PS₅Cl | 90 | 10 |
| Example 8 | | | |
| Comparative | Li₆PS₅Cl | 85 | 15 |
| Example 9 | | | |
| Example 1 | Li_{3.15}Y_{1/3}Er_{1/3}Yb_{1/3}Cl_{5.85}O_{0.15} | 99 | 1 |
| Example 2 | Li_{3.15}Y_{1/3}Er_{1/3}Yb_{1/3}Cl_{5.85}O_{0.15} | 98 | 2 |
| Example 3 | Li_{3.15}Y_{1/3}Er_{1/3}Yb_{1/3}Cl_{5.85}O_{0.15} | 97 | 3 |
| Example 4 | Li_{3.15}Y_{1/3}Er_{1/3}Yb_{1/3}Cl_{5.85}O_{0.15} | 96 | 4 |
| Example 5 | Li_{3.15}Y_{1/3}Er_{1/3}Yb_{1/3}Cl_{5.85}O_{0.15} | 95 | 5 |

### Experimental Example 1. Volume Ratio of Solid Electrolyte and Carbon in Composite and Measurement of Electronic Conductivity Thereof

200 mg of the composite prepared in each of Example and Comparative Example above was put into a disk-shaped mold and pressurized under 370 MPa to form a pellet. Thereafter, titanium electrodes were respectively placed on both opposing surfaces of the composite pellet, and a DC voltage of 0.5 V was applied thereto. A magnitude of the generated current was measured to measure the electronic conductivity of each sample.

Further, the solid electrolyte volume content and the carbon volume content in each composite were calculated using a mass and a density of the injected sample.

The measurement results are summarized in Table 2 as set forth below.

TABLE 2

| | Solid | | |
|---|---|---|---|
| | electrolyte | | Electronic |
| | volume | Carbon volume | conductivity |
| | content(%) | content(%) | (S/cm) |
| Comparative | 92.09 | 7.91 | 2.7 × 10⁻⁷ |
| Example 1 | | | |
| Comparative | 89.63 | 10.37 | 3.5 × 10⁻⁷ |
| Example 2 | | | |
| Comparative | 87.25 | 12.75 | 8.9 × 10⁻⁷ |
| Example 3 | | | |
| Comparative | 84.95 | 15.05 | 1.8 × 10⁻⁶ |
| Example 4 | | | |
| Comparative | 82.72 | 17.28 | 2.1 × 10⁻⁵ |
| Example 5 | | | |
| Comparative | 80.55 | 19.45 | 6.5 × 10⁻⁴ |
| Example 6 | | | |
| Comparative | 78.46 | 21.54 | 5.3 × 10⁻³ |
| Example 7 | | | |
| Comparative | 76.43 | 23.57 | 3.9 × 10⁻² |
| Example 8 | | | |
| Comparative | 67.12 | 32.88 | 9.3 × 10⁻² |
| Example 9 | | | |
| Example 1 | 96.44 | 3.56 | 1.1 × 10⁻⁹ |
| Example 2 | 93.06 | 6.94 | 3.5 × 10⁻⁹ |
| Example 3 | 89.84 | 10.16 | 2.4 × 10⁻⁵ |
| Example 4 | 86.78 | 13.22 | 1.2 × 10⁻² |
| Example 5 | 83.86 | 16.14 | 8.2 × 10⁻² |

From the results in Table 2 as set forth above, a following fact may be identified: the same amount of the carbon-based conductive material is added during the composite preparation process, and in this case, in preparing the composite using the specific chloride-based solid electrolyte used in the present disclosure and the carbon-based conductive material, the volume content of carbon in the composite increases such that the electronic conductivity increases, compared to when the sulfide-based solid electrolyte is used.

### Experimental Example 2. Measurement of the Mass Ratio of Conductive Material in the Composite

In the composite prepared in each of Example and Comparative Example above, the mass ratio of each of the elements of the solid electrolyte and carbon was measured using SEM-EDXS, and based on this measurement, the mass ratio of the solid electrolyte and the conductive material in the composite was measured. The results are summarized in Table 3 as set forth below.

TABLE 3

| | Solid | Conductive |
|---|---|---|
| | electrolyte | material mass |
| | mass content(%) | content(%) |
| Comparative | 96.39 | 3.61 |
| Example 1 | | |
| Comparative | 96.43 | 3.57 |
| Example 2 | | |
| Comparative | 95.64 | 4.36 |
| Example 3 | | |
| Comparative | 94.38 | 5.62 |
| Example 4 | | |
| Comparative | 93.37 | 6.63 |
| Example 5 | | |
| Comparative | 92.21 | 7.79 |
| Example 6 | | |
| Comparative | 91.72 | 8.28 |
| Example 7 | | |
| Comparative | 90.35 | 9.65 |
| Example 8 | | |
| Comparative | 84.20 | 15.80 |
| Example 9 | | |
| Example 1 | 99.75 | 0.25 |
| Example 2 | 97.72 | 2.28 |
| Example 3 | 97.23 | 2.77 |
| Example 4 | 96.78 | 3.22 |
| Example 5 | 95.60 | 4.40 |

From the above results, it may be identified that the ratio between the solid electrolyte and the conductive material used in the composite preparation process is not equal to the ratio between the two components identified in the actual composite. Thus, it may be identified that a portion of of the conductive material used in the mixing process forms the composite.

Furthermore, when the results of Table 2 and Table 3 are combined with each other, it may be identified that when the weight content of the conductive material in the composite is 2.5 wt % or greater, this is particularly advantageous in terms of the electronic conductivity.

### Experimental Example 3. Evaluation of Stability of Composite Under High Voltage Condition

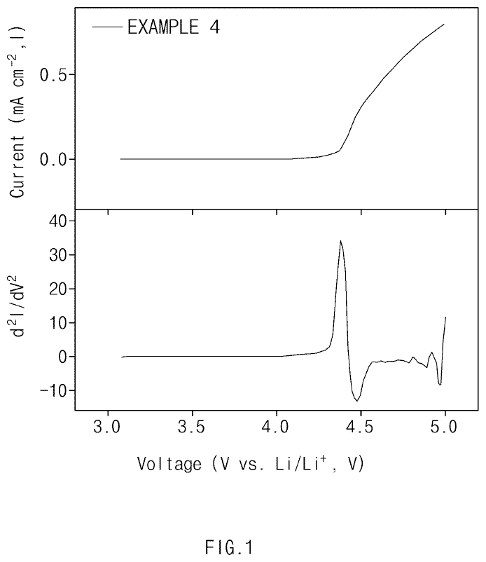

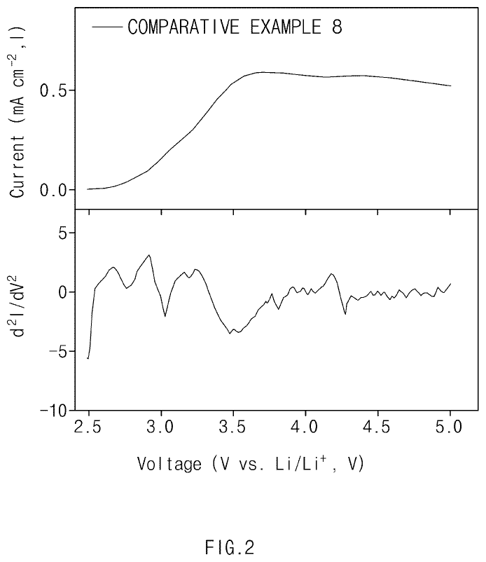

The stability of each of the composite of Comparative Example 8 and the composite of Example 4 under a high voltage condition was evaluated using a cyclic voltammetry experiment. The composite of each of Comparative Example 8 and Example 4, the solid electrolyte layer (separator) and a Li foil were sequentially stacked on p of another to prepare an electrochemical cell, and then, a voltage applied thereto was increased at a rate of 1 mV/s. At this time, the generation of oxidation current was observed. Thereafter, the second order derivative of the measured current (I)-voltage (V) graph was obtained, and a voltage at a point where the maximum value (extreme value) was observed for the first time was read to determine the upper limit of the oxidation stability. The graph directed to the composite of Example 4 is shown in FIG. 1, and the graph directed to the composite of Comparative Example 8 is shown in FIG. 2, and a voltage value at which the oxidation current occurs in each composite is summarized in Table 4 as set forth below.

TABLE 4

| Voltage value at which oxidation | | Comparative |
|---|---|---|
| current occurs | Example 4 | Example 8 |
| (V vs. Li/Li⁺) | 4.38 | 2.67 |

As identified through the results of FIGS. 1 and 2 and Table 4 as set forth above, the composite according to Example has better oxidation stability.

### Experimental Example 4. Evaluation of all-Solid-State Battery to which Composite is Applied

The composite of each of Comparative Examples 6 to 8 and Examples 3 to 5 selected based on the measured electronic conductivity was applied to the all-solid-state battery which was evaluated.

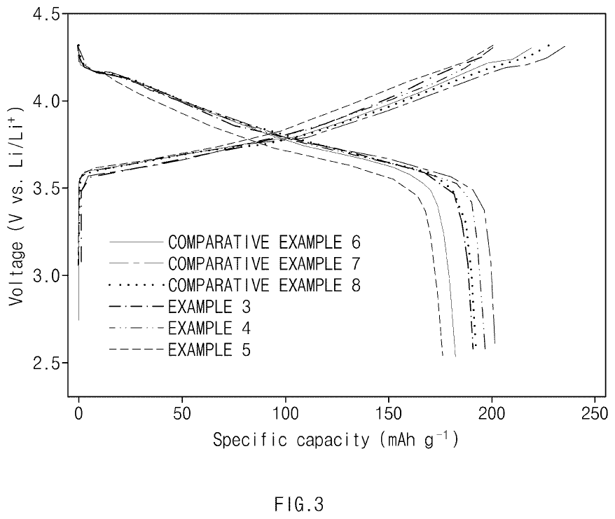

Specifically, a NCM-based positive electrode active material and the composite were mixed with each other at a weight ratio of 80:20 to form an electrode composite. Separately therefrom, 150 mg of Li₆PS₅Cl was formed into a disk-shaped pellet, and 20 mg of the coated positive electrode material and the lithium-indium alloy were respectively attached to both opposing surfaces of the pellet to prepare an all-solid-state battery. Afterwards, a charge/discharge experiment of the prepared all-solid-state battery was performed at a temperature of 30° C. and a current of 0.05 C. The charge capacity, the discharge capacity, and the initial coulombic efficiency of each all-solid-state battery as identified through the charge/discharge experiment are summarized in Table 5 as set forth below, and the charge/discharge graph is shown in FIG. 3.

TABLE 5

| | Charge capacity | Discharge capacity | Initial coulombic |
|---|---|---|---|
| | (mAh/g) | (mAh/g) | efficiency (%) |
| Comparative | 218.51 | 182.40 | 83.47 |
| Example 6 | | | |
| Comparative | 234.51 | 201.97 | 86.12 |
| Example 7 | | | |
| Comparative | 225.30 | 192.62 | 85.49 |
| Example 8 | | | |
| Example 3 | 210.79 | 191.06 | 90.64 |
| Example 4 | 219.62 | 196.49 | 89.47 |
| Example 5 | 200.80 | 176.39 | 87.84 |

As seen from the results of Table 5 and FIG. 3, it was identified that the positive electrode material using the composite of the present disclosure exhibited excellent initial coulombic efficiency, which means that the efficiency and performance of the all-solid-state battery may be improved using the solid electrolyte-conductive material composite of the present disclosure.

### Experimental Example 5. Evaluation of Positive Electrode Material Coating to which Composite is Applied

The composite of Example 4 was mixed with the NCM-based positive electrode material, and the mixture was homogenized. Thus, a coating layer was introduced on the surface of the positive electrode material. Thereafter, the coated positive electrode material was uniformly mixed with the sulfide-based solid electrolyte Li₆PS₅Cl and the conductive material to prepare the electrode composite. This was named Example A.

In Comparative Example, the electrode composite was prepared by mixing the positive electrode material with the solid electrolyte and the conductive material without forming the coating layer on the positive electrode material at all (Comparative Example A). Alternatively, the coating layer was formed only using the chloride-based solid electrolyte, and then, the coated positive electrode material was mixed with the sulfide-based solid electrolyte and the conductive material to prepare the electrode composite (Comparative Examples B to E).

The contents (weight %) of the active material, the coating layer, the solid electrolyte, and the conductive material used in the prepared electrode composite, and the composition of the coating layer are summarized in Table 6 as set forth below.

TABLE 6

| | | | | | Composition of coating layer |
|---|---|---|---|---|---|
| | | | | | (based on weight) |
| | Active | Coating | Solid | Conductive | (Li_{3.15}YCl_{5.85}0_{0.15}:Carbon- |
| | material | layer | electrolyte | material | based conductive material) |
| Example A | 85 | 2 | 12 | 1 | 96:4 |
| Comparative | 85 | 0 | 14 | 1 | — |
| Example A | | | | | |
| Comparative | 85 | 2 | 12 | 1 | 100:0 |
| Example B | | | | | |
| Comparative | 85 | 3 | 11 | 1 | 100:0 |
| Example C | | | | | |
| Comparative | 85 | 5 | 9 | 1 | 100:0 |
| Example D | | | | | |
| Comparative | 85 | 3 | 11 | 2 | 100:0 |
| Example E | | | | | |

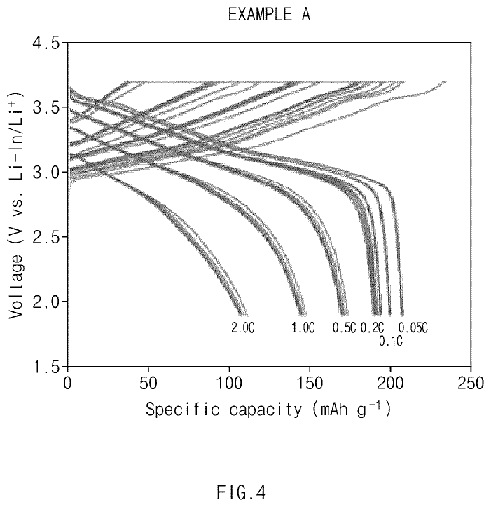

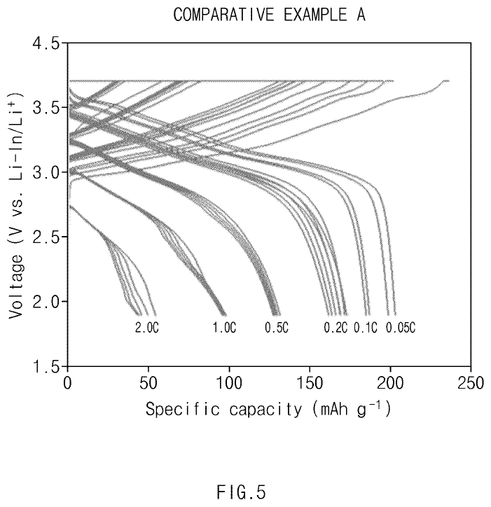

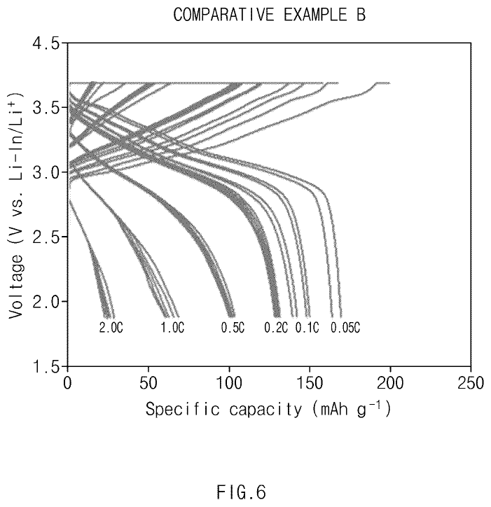

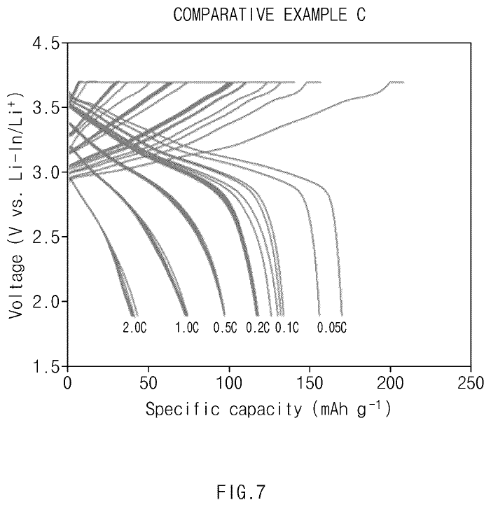

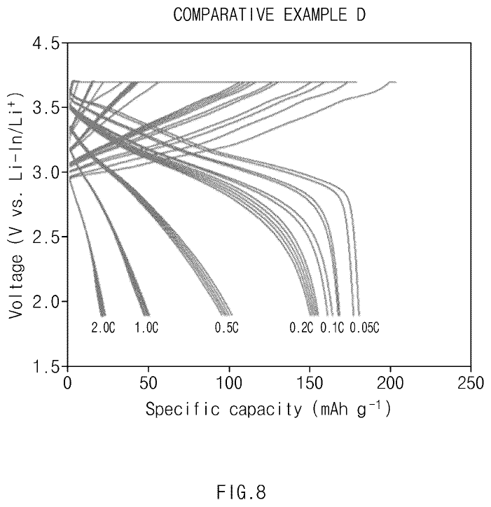

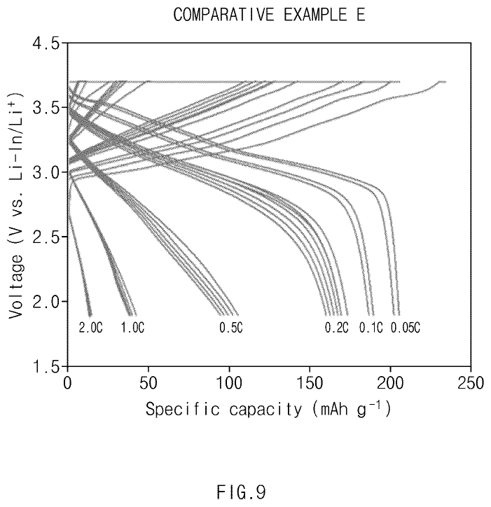

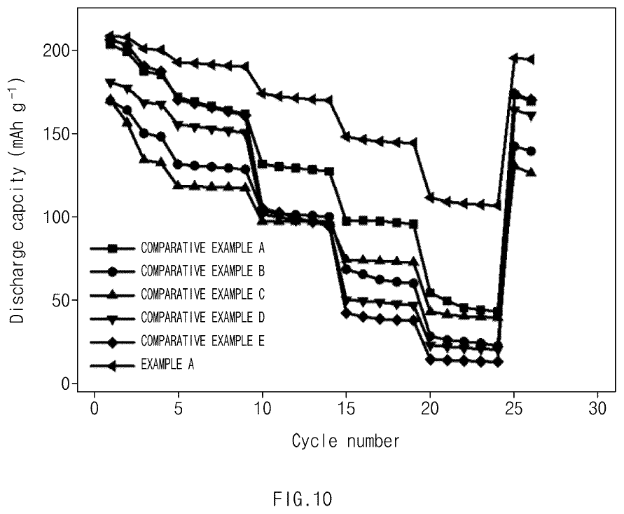

A battery was fabricated using the electrode composite of each of Example A and Comparative Examples A to E, and then, a charge/discharge evaluation of the battery was performed (charge/discharge voltage range: about 2.5 to about 4.3 V (vs. Li/Li⁺), C-rate: 0.05-0.1-0.2-0.5-1.0-2.0 C, 5 cycles per each test). The results are shown in FIG. 4 to FIG. 10 and Table 7 as set forth below.

TABLE 7

| | Discharge | Discharge | | Initial |
|---|---|---|---|---|
| | capacity@0.05 | capacity@0.5 | q2/ | efficiency |
| | C(mAh/g)-q1 | C(mAh/g)-q2 | q1(%) | (%) |
| Example A | 207.58 | 173.33 | 83.50 | 88.72 |
| Comparative | 202.37 | 131.21 | 64.84 | 85.92 |
| Example A | | | | |
| Comparative | 168.9 | 103.07 | 61.02 | 84.95 |
| Example B | | | | |
| Comparative | 169.53 | 97.03 | 57.23 | 81.59 |
| Example C | | | | |
| Comparative | 179.93 | 101.35 | 56.33 | 88.80 |
| Example D | | | | |
| Comparative | 205.29 | 105.14 | 51.22 | 87.61 |
| Example E | | | | |

Comparative Example A employed the positive electrode material that did not include the coating layer at all, and exhibited a lower discharge capacity than that of Example A of the present disclosure at high current density. Furthermore, each of Comparative Examples B to E having the coating layer made only of the solid electrolyte, and exhibited a low discharge capacity and low efficiency because the solid electrolyte coating layer did not transmit electrons therethrough.

On the other hand, it was identified that Example A exhibited both the excellent discharge capacity and the excellent efficiency because the coating layer with excellent balance between electronic conductivity and ionic conductivity was applied to the positive electrode active material.

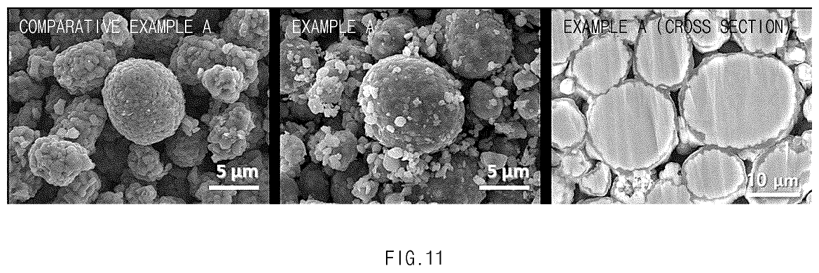

In addition, the positive electrode active material of Example A and the positive electrode active material of Comparative Example A which did not have the coating layer were observed using SEM. This observation is shown in FIG. 11. As seen from FIG. 11, it was identified that the composite of the present disclosure was uniformly coated on the surface of the positive electrode active material, and the coating thickness was approximately 90 to 150 nm.

The composite of the present disclosure is prepared by combining the chloride-based solid electrolyte having stability at high voltage with a conductive material into the composite, so that the composite may have excellent stability even under battery operating conditions, and thus may exhibit excellent ion conductivity and electronic conductivity while not being oxidized during charging.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A composite comprising:
a solid electrolyte represented by a following Chemical Formula 1; and
a carbon-based conductive material: 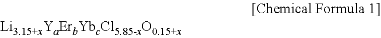
where in the Chemical Formula 1,
$$0 \leq a \leq 1 , 0 \leq b \leq 1 , 0 \leq c \leq 1 , a + b + c = 1 , - 0.1 \leq x \leq 0.1 .$$

2. The composite of claim 1, wherein the composite is at least one selected from the group consisting of Li_{3.15}YCl_{5.85}O_{0.15}, Li_{3.15}ErCl_{5.85}O_{0.15}, Li_{3.15}YbCl_{5.85}O_{0.15} and Li_{3.15}Y_{1/3}Er_{1/3}Yb_{1/3}Cl_{5.85}O_{0.15}.

3. The composite of claim 1, wherein the carbon-based conductive material is at least one selected from the group consisting of carbon black, single-walled carbon nanotubes, multi-walled carbon nanotubes, and graphene.

4. The composite of claim 1, wherein a content of the carbon-based conductive material in the composite is in a range of 0.1 wt % inclusive to 10 wt % inclusive.

5. The composite of claim 1, wherein an oxidation current flows in the composite at a voltage of 4.25 V (vs. Li/Li⁺) or greater.

6. A positive electrode material comprising:
a positive electrode active material; and
a coating layer formed on at least a portion of a surface of the positive electrode active material,
wherein the coating layer includes the composite according to claim 1.

7. The positive electrode material of claim 6, wherein the positive electrode active material is an oxide active material or a sulfide active material.

8. The positive electrode material of claim 6, wherein the positive electrode active material is a lithium metal oxide-based positive electrode active material having a layered structure.

9. The positive electrode material of claim 6, wherein a thickness of the coating layer is in a range of 50 nm inclusive to 200 nm inclusive.

10. The positive electrode material of claim 6, wherein a weight ratio between the positive electrode active material and the composite is in a range of 70:30 to 99:1.

11. A positive electrode comprising:
a positive electrode active material layer; and
a current collector,
wherein the positive electrode active material layer includes the positive electrode material according to claim 6.

12. The positive electrode of claim 11, wherein the positive electrode active material layer includes a solid electrolyte and a conductive material.

13. The positive electrode of claim 12, wherein the solid electrolyte contained in the positive electrode active material layer is a sulfide-based solid electrolyte.

14. An all-solid-state battery comprising:
the positive electrode according to claim 11;
a negative electrode; and
a solid electrolyte layer interposed between the positive electrode and the negative electrode.

15. The all-solid-state battery according to claim 14, wherein the solid electrolyte layer includes a conductive material and a binder.

16. The all-solid-state battery according to claim 14, wherein the solid electrolyte layer includes a solid electrolyte, the solid electrolyte including at least one selected from the group consisting of a sulfide-based solid electrolyte, the chloride-based solid electrolyte, or the oxide-based solid electrolyte.
